(19) United States
(12) Patent Application Publication
(10) Pub. No.: US 2013/0238111 A1
(43) Pub. Date: Sep. 12, 2013

(54) QUANTIFYING DEFECTS AND HANDLING THEREOF

(71) Applicant: APPLE INC., Cupertino, CA (US)

(72) Inventors: Lucas A. WHIPPLE, Belmont, CA (US); Simon R. LANCASTER-LAROCQUE, Gloucester (CA); Erik D. SUOMI, Palo Alto, CA (US); Timothy Richard WEBB, Portland, OR (US); Kyung Y. KIM, Portland, OR (US); Cameron W. SCHNUR, Portland, OR (US); Bruce W. BALL, Ann Arbor, MI (US); Carl CAI, Beaverton, OR (US)

(73) Assignee: APPLE INC., Cupertino, CA (US)

(21) Appl. No.: 13/797,944

(22) Filed: Mar. 12, 2013

Related U.S. Application Data
(60) Provisional application No. 61/609,830, filed on Mar. 12, 2012.

(51) Int. Cl. G05B 19/418

(52) U.S. Cl. CPC G05B 19/41875
USPC 700/110

(57) ABSTRACT

A method, system, and apparatus for intelligent application of a finishing process a surface of a housing is described. In one embodiment, at least a portion of the surface of the housing is imaged. In one embodiment, the image can be rendered using an optical imager such as a standard or high definition camera. In one embodiment, multiple cameras can be used to assist in defining location, size, and depth of surface defects. In one embodiment, an optical imaging device can be used to image surface defects under wet conditions where the surface of the housing is covered with a layer of slurry.

### CROSS-REFERENCE TO RELATED APPLICATIONS

This application claims priority under 35 U.S.C. 119(e) to U.S. Provisional Application No. 61/609,830, filed Mar. 22, 2012, and entitled “QUANTIFYING DEFECTS AND HANDLING THEREOF”, which is incorporated herein by reference in its entirety for all purposes.

### BACKGROUND

1. Field of the Invention

This invention relates generally to consumer electronics and computing devices. More particularly, detecting and removing surface defects during a finishing operation is discussed.

2. Related Art

The proliferation of high volume manufactured, portable electronic devices has encouraged innovation in both functional and aesthetic design practices for enclosures that encase such devices. Manufactured devices can include a casing that provides an ergonomic shape and aesthetically pleasing visual appearance desirable to the user of the device. In order to provide an exemplary user experience, the casing must be free of defects that be can both seen and felt. Currently used finishing processes, however, rely upon removing excess amounts of material in order to remove the defects (such as scratches). For example, a single defect can result in a removal of material from the entire casing during the finishing process causing a substantial amount of waste material (such as aluminum dust in the case of aluminum casings) that can be environmentally damaging, and causing significant increases in processing times.

Thus there exists a need for a method and an apparatus for efficiently characterizing surface defects and using the characterization to customize a subsequent finishing operation.

### SUMMARY

The invention relates to methods, and apparatus for efficiently detecting and handling surface defects both before and during a finishing operation.

In a first embodiment, a method of finishing a housing surface is disclosed. The method is carried out by performing at least the following steps: (1) analyzing imagery of at least a portion of the housing surface for a surface defect; (2) determining whether a depth dimension of each detected surface defect is within a predefined range of depths considered reparable during a finishing operation; (3) mapping each surface defect that is determined to be reparable to a position on the housing surface; and (4) modifying a finishing process of the housing surface in real-time in accordance with a determined depth dimension and location on the housing surface of each of the reparable defects. Execution of the finishing process with a finishing tool creates a substantially blemish free surface finish across the housing surface.

In some cases, if at least one defect is determined to not be reparable, then the finishing process for that particular housing is not initiated and the housing is passed to a rework flow. In this way, valuable manufacturing time and resources are not expended on a housing that cannot be finished to a quality level deemed acceptable.

In another embodiment a method of adapting a finishing profile to a housing surface is disclosed. The method is carried out by performing at least the following steps: (1) imaging the housing surface; (2) analyzing the imagery of the housing surface to detect defects disposed along the housing surface; (3) determining which of the detected defects are within a predefined range of depths considered reparable during a finishing operation; and (4) configuring the finishing profile for creation of a desired finish along the surface of the housing and removal of each of the reparable defects during the finishing operation.

In yet another embodiment aspect a finishing system for applying a finishing operation to a surface of a housing is disclosed. The finishing system can include at least the following components: (1) a vision system configured to provide imagery of any surface defects disposed along the surface of the housing; (2) a processor configured to analyze the provided imagery and to design a finishing profile for creating a desired surface finish on the surface of the housing and removing any detected surface defects from the surface of the housing; and (3) a finishing tool configured to execute the finishing profile. The processor is in communication with both the finishing tool and the vision system and is configured to stop a finishing operation for a housing, which is determined to have a defect with a depth dimension exceeding a predefined depth threshold.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings in which:

FIG. 1 illustrates a system suitable for surface finishing in accordance with the described embodiments;

FIG. 2A illustrates a graph showing a relationship between observed surface defects and a re-work threshold value;

FIG. 2B illustrates a graph showing a cross-sectional view of a portion of a surface before undergoing a finishing operation;

FIG. 2C illustrates a graph showing a cross-sectional view of a portion of a surface after undergoing a finishing operation;

FIG. 3A shows a top view of a housing having a number of defects;

FIG. 3B shows the housing from FIG. 3A overlaid by a number of imaging footprints;

FIG. 3C shows the housing from FIG. 3B overlaid with imaging footprints associated with detected defects;

FIG. 3D shows how a high resolution imaging system can be used to further characterize a detected defect;

FIG. 3E shows a magnified view of a high resolution footprint using linear imaging;

FIG. 3F shows a magnified view of a high resolution footprint using non-linear imaging;

FIG. 3G shows a non-linear imaging device;

FIG. 3H shows a non-linear imaging device;

FIG. 3I shows which portions of the housing are affected by a finishing operation designed to remove defects;

FIG. 3J shows another finishing path specifically configured to remove a number of detected defects;

FIG. 4A shows a representation of an integrated handler/imaging system in accordance with the described embodiments;

FIG. 4B shows a finishing system configured to both characterize and apply finishing operations to a part;

FIG. 5A shows an imaging system using multiple light sources;

FIG. 5B shows an imaging system using multiple light sources and a moving imaging device;

FIG. 5C shows an imaging system using multiple light sources and a moving imaging device;

FIG. 5D shows an imaging system using multiple light sources and a moving imaging device;

FIG. 5E shows an imaging system using multiple light sources and a moving imaging device;

FIG. 6 shows a flowchart detailing a finishing process in accordance with the described embodiments; and

FIG. 7 shows a flowchart detailing a surface characterization process 600.

### DETAILED DESCRIPTION OF SELECTED EMBODIMENTS

Reference will now be made in detail to selected embodiments an example of which is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as can be included within the spirit and scope of the invention as defined by the appended claims.

The embodiments described herein relate to a method, system, and apparatus for intelligent application of a finishing process to a surface of a housing (also referred to as a casing, enclosure, etc.). More particularly, a vision system and a robotic finisher are used together where information from images captured by the vision system is used to dynamically adjust a finishing profile. In one embodiment, a finishing path for a robotically controlled finishing tool is adjusted using information from the images in the form of defect characteristics to optimize the finishing path. Optimization of the finishing path can include adjustments to any one or any combination of a force, a speed, a direction, and an operating parameter of the finishing tool in real-time during the finishing process.

The vision system for scanning a surface of a housing can be configured in a number of different ways. In some embodiments a large scale CCD (Charged-coupled Device) imager can be used to provide a two dimensional image of the surface of the housing. The CCD imager can be configured to take a single two-dimensional image or in order to get increased detail a number of images can be captured of the surface at close distances from the surface of the part. A macro lens can be attached to the CCD imager in some cases providing a 1:1 magnification ratio of the surface of the housing (in other embodiments a much higher magnification ratio can be desired). The captured images can be subsequently stitched together to provide a defect map of the housing's surface. By tracking a spatial position of the camera relative to the housing each detected defect can be correlated or mapped to a specific position on the particular housing. In some embodiments the images can be used to create a surface map of the surface of the housing, while in other embodiments the images can be overlaid onto a pre-existing computer aided drafting (CAD) model of the housing to provide increased detail with respect to the defect positions and orientations. Furthermore, in conjunction with the imaging of the surface of the housing, sufficient lighting is important to prevent shadows from masking details of the detected defects. When taking images at close distances from the surface of the housing, multiple light sources can be useful for preventing shadows, caused by a position of the imaging device, from obscuring portions of images of the detected defects. Side lighting the surface with respect to the imaging device can be particularly effective as it can substantially prevent shadowing caused by the imaging device itself

In another embodiment a high-resolution three-dimensional scanner can be used in conjunction with the CCD imager to provide increased fidelity of the detected defects. For example, a relatively low-resolution image or images can be taken of the surface of the housing. The low resolution image can determine an approximate location of any defects by locating shadows created by scratches and dents in the surface. In some embodiments, a severity metric can be created using data from the image. A severity value, implying depth information, can be assigned to each defect based on the size of the visual distortion and the reduction in light emitted from any detected shadows. Any regions that register a severity metric over a threshold value can then be analyzed using a secondary scanning process.

In the secondary scanning process, a higher-resolution three-dimensional scanner such as for example, a line laser, an interferometer, or a confocal sensor can characterize only portions of the surface having the identified irregularities. In addition to better characterizing the detected defects, the high-resolution scanner provides three-dimensional data characterizing the defects. This increased level of detail can help provide answers to the following important questions: (1) whether the defect is too deep for repair during the finishing process; and (2) if the detected defect is repairable during the finishing process, then how much additional finishing is required? If any of the detected defects are too deep for the finishing processing then the part can be either discarded or sent elsewhere for rework. Otherwise, the high-resolution imagery pertaining to each of the detected defects can be sent to an analysis module for determining an appropriate finishing profile for the finishing tool.

The finishing process can be modified in accordance with characteristics of the defects observed along the surface of the housing. Speed, applied pressure, and direction of motion of a finishing tool can be modified in accordance with selected defect characteristics. For example, if a surface defect is determined to extend a substantial distance across the surface of the housing, then the finishing tool can be directed to conduct additional finishing operations over the extended surface defect.

In yet another embodiment, a three-dimensional imaging system can be used to scan the entire surface of the part or at least portions of the part most susceptible to defects. The three-dimensional imaging system can include a confocal lens arrangement. Such an arrangement allows extremely detailed optical images to be taken at varying depths of the defect, thereby providing a highly detailed optical characterization of the defect. Due to the level of detail desired from such an operation, stabilization of the imaging device can help prevent motion blur during imaging operations. The three-dimensional imaging system can be integrally formed with a robotic part handler and a vibration buffer. The robotic part handler can be configured to provide a stable platform from which the imaging system can operate. In some embodiments the robotic part handler can be configured to allow the imaging system to be translated in at least one dimension. The vibration buffer substantially eliminates vibrations caused by instability of the robotic arm. In this way, the three-dimensional imaging system and the robotic handler can be in the same reference frame, thereby providing a stable platform from which clear imagery can be taken.

In one embodiment, an optical imaging device can be used to image surface defects under wet conditions when the surface of the housing is covered with a layer of slurry or liquid such as water. The three-dimensional imaging system can be integrally formed with a robotic part handler and a vibration buffer. In this configuration, the 3D imaging system and the robotic handler are in the same reference frame that in conjunction with the vibration buffer substantially reduces image defects caused by vibration. The ability to conduct image-scanning operations in wet conditions allows for an intermediate scan to be performed on the housing without cleaning up the surface of the housing. Since the slurry or liquid need not be removed, a subsequent finishing operation can be conducted more efficiently in situations where at least one of the defects requires further finishing operations. It should also be noted that any of the aforementioned embodiments can be adapted for use with other non-visible wavelengths, such as for example infrared and ultraviolet wavelengths. Analysis of other frequency spectrums can provide additional information useful in characterizing detected defects. Such embodiments can be implemented by use of imaging equipment configured to monitor the other desired frequency spectrums.

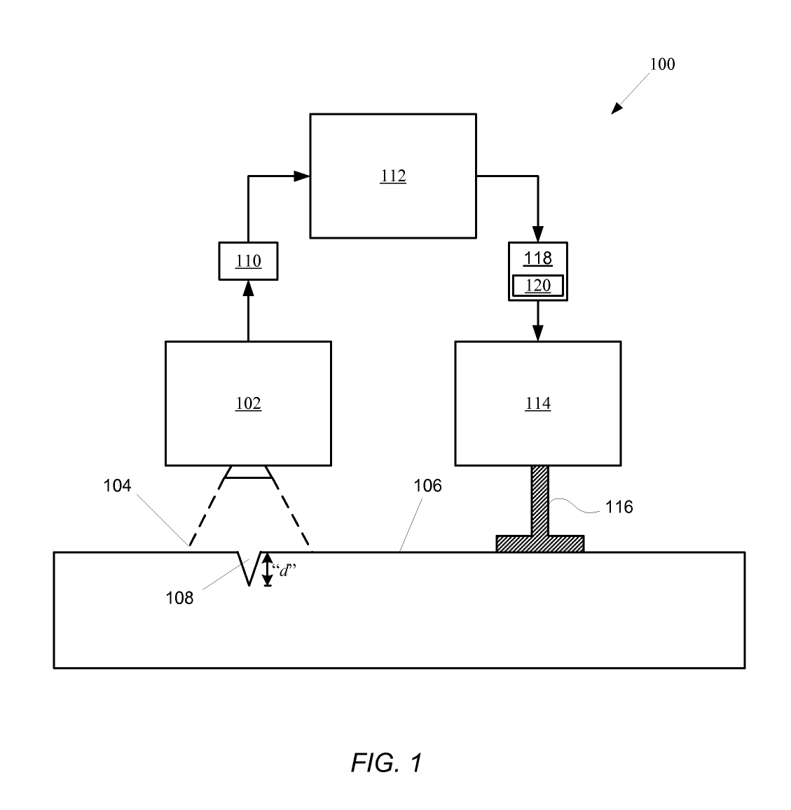

These and other embodiments related to the detecting and handling of surface defects both before and during a finishing operation are discussed below with reference to FIGS. 1-7; however, those skilled in the art will readily appreciate that the detailed description given herein with respect to these figures is for explanatory purposes only and should not be construed as limiting.

FIG. 1 illustrates a functional block diagram of system 100 suitable for surface finishing in accordance with the described embodiments. System 100 can include vision system 102 for capturing an image in an image area 104 of surface 106. In addition to conducting image-capturing operations, vision system 102 can be configured to conduct basic image analysis on captured images. For example, vision system can have a data storage system including a reference image or images of a defect free surface. Unless the captured image differs noticeably from the defect free reference image, the captured image can be discarded. This allows resources to be saved by conducting detailed image analysis only on images that have been determined to contain a defect; however, in some cases, all images 110 captured by vision system 102 can be passed to processor 112. The described selective image delivery arrangement can be particularly useful when processor 112 does not possess sufficient image processing capability to adequately process images 110.

In those instances where portion 104 includes at least detected defect 108, vision system 102 can pass image 110 to processor 112 for analysis. Processor 112 can be in communication with finishing system 114 arranged to apply finishing tool 116 to surface 106. In one embodiment, finishing tool 116 can be mobile in which case surface 106 can be stationary. In one embodiment, finishing tool 116 can be stationary and surface 106 can move under the control of processor 112 or at least influenced by information provided by processor 112. In one embodiment, only finishing tool 116 is mobile and moves with respect to stationary surface 106 under the influence of processor 112. In this case, processor 112 can send information in the form of instructions 118 to finishing system 114 that in turn is used to control finishing tool 116. In one embodiment, finishing system 114 can take the form of robotic finishing system 114. Moreover, information 118 can include at least finishing profile 120 used by robotic finishing system 114 to control finishing tool 116 during a finishing operation. Finishing profile 120 can include instructions related to finishing parameters such as {force F, finishing speed S, finishing direction D} used by robotic finishing system 114. For example, profile 120 can be used to cause finishing tool 116 to apply finishing force F at finishing speed S in finishing direction D at surface 106.

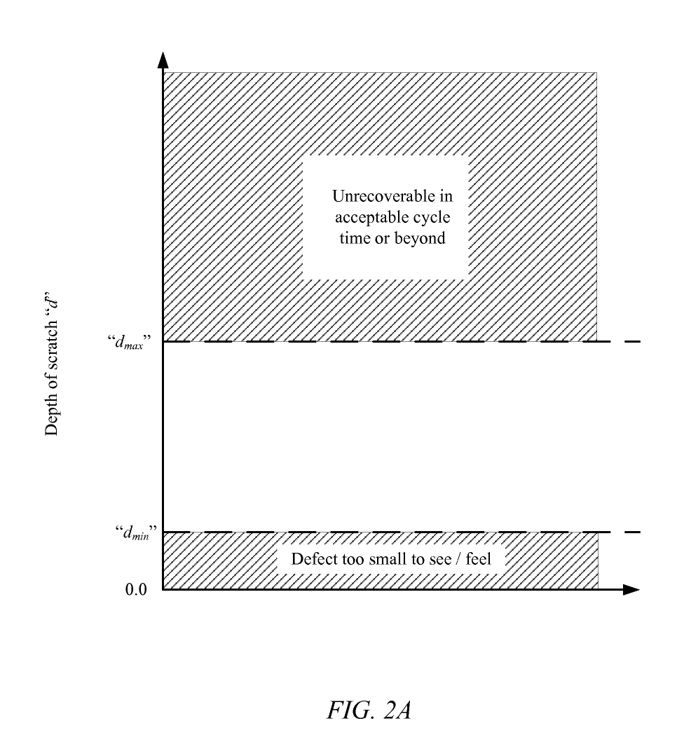

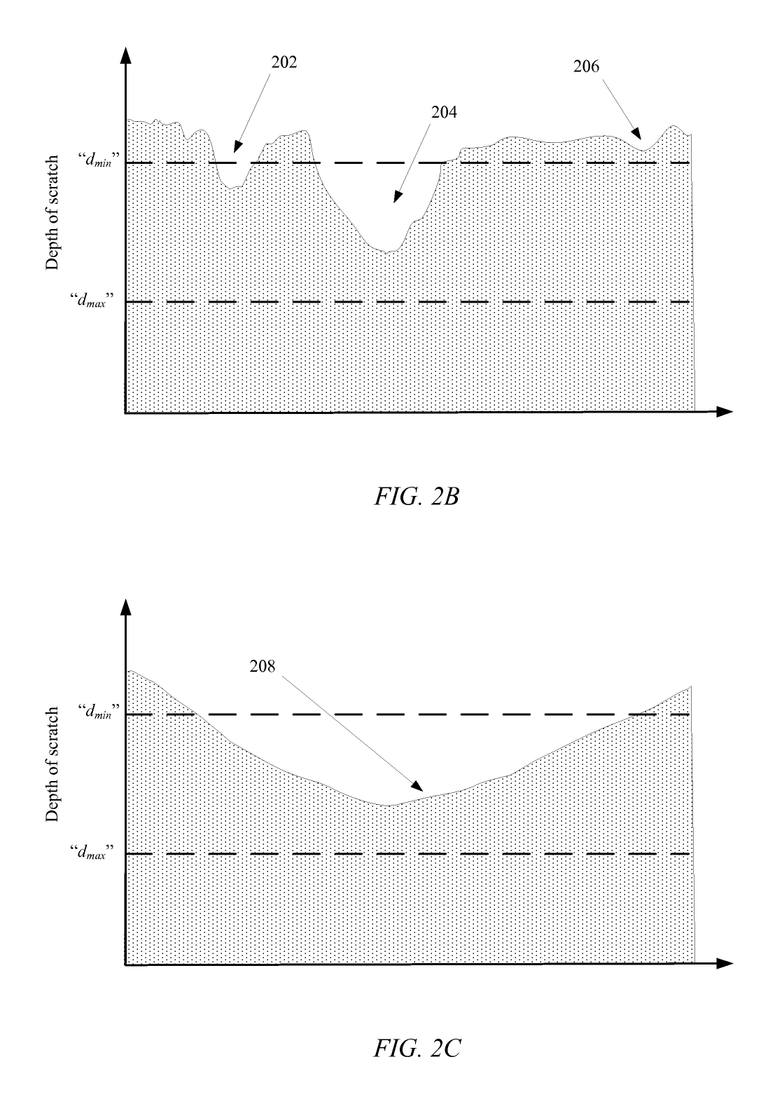

Processor 112 can evaluate characteristics of any surface defect prior to initiation of the finishing process. In this way, as shown in FIG. 2A, if processor 112 determines that at least one defect has depth d that is greater than a pre-determined amount dₘₐₓ (such as 50 microns) that is deemed to be not reparable within an acceptable cycle time or other manufacturing constraints, then processor 112 can indicate that the part being scrutinized cannot be repaired. At that time the part can be either discarded or re-directed to a rework process. At the other extreme, if processor 112 determines that no defects have a depth greater than a minimum pre-determined amount dₘᵢₙ (such as 10 microns that is generally not viewable), then processor 112 can indicate that the part being scrutinized does not need to undergo repair. In such a case a basic finishing operation can be conducted that removes only enough material to provide a desired surface finish or texture. In some embodiments, such an operation might only remove 5 microns from a surface of the housing. In this way, valuable manufacturing time and resources can be preserved with the elimination of unwarranted defect removal procedures. It should be noted that dₘᵢₙ can vary widely depending on the surface finish being applied. For example, a reflective surface can show surface defects much more easily than a matte surface. Depth dₘₐₓ can vary in accordance with structural requirements of an associated housing and also with an amount of time available to be spent during the finishing process.

FIG. 2B shows an exemplary cross-section of a portion of a housing having two adjacent defects 202 and 204. Defects 202 and 204 are candidates for removal during a finishing operation because they are deeper than dₘᵢₙ and shallower than dₘₐₓ. Surface defect 206 is not a concern because it does not extend below dₘᵢₙ, and is not tangible given a desired surface finish of the housing. FIG. 2C shows how a finishing operation can remove defects 202 and 204. By applying finishing force to a surface of the housing a gradual gradient can be formed into the surface of the housing creating a single depression 208 that removes both defect 202 and defect 204. Because of the gradual nature of depression 208 with respect to a surrounding surface of the housing, depression 208 can be substantially undetectable during day-to-day use of the housing.

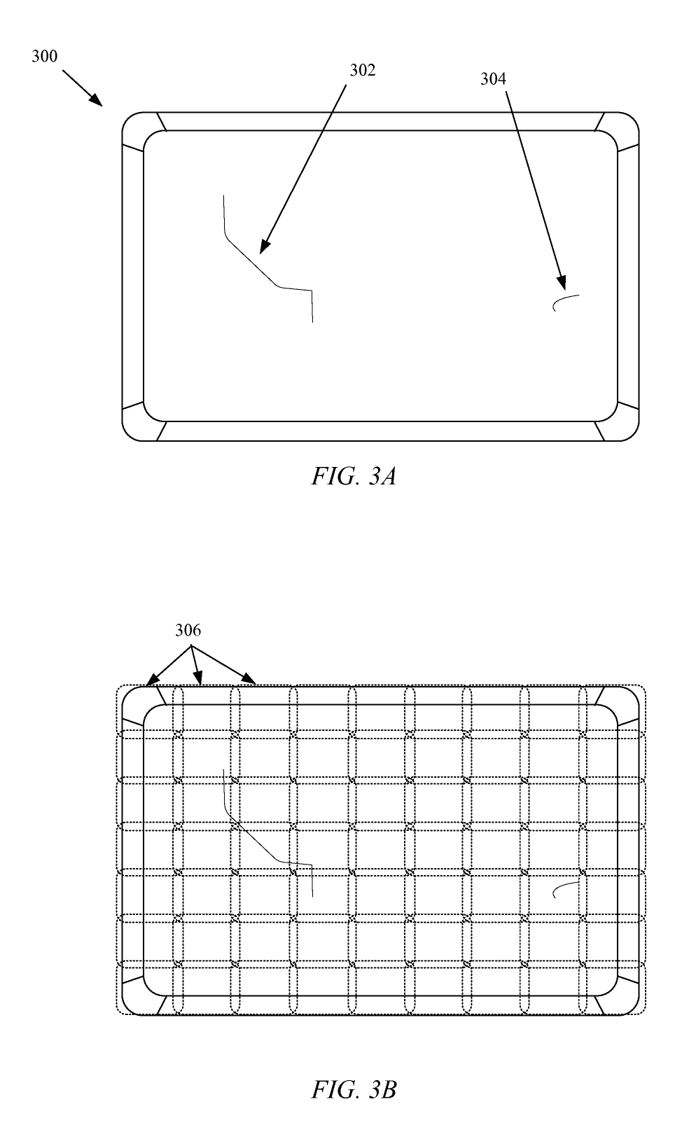

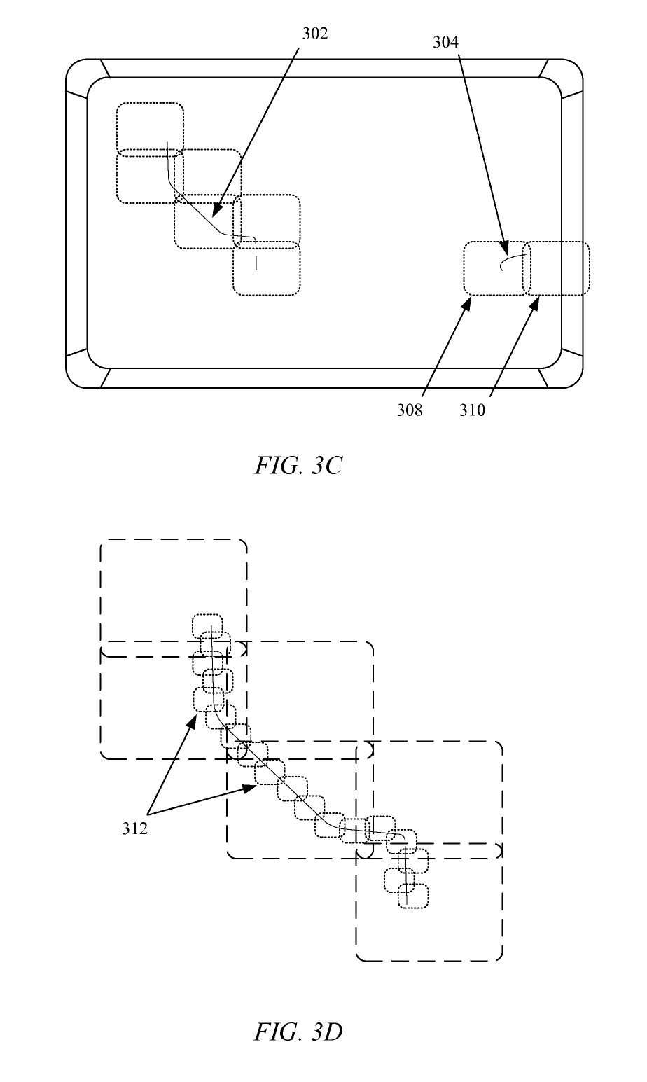

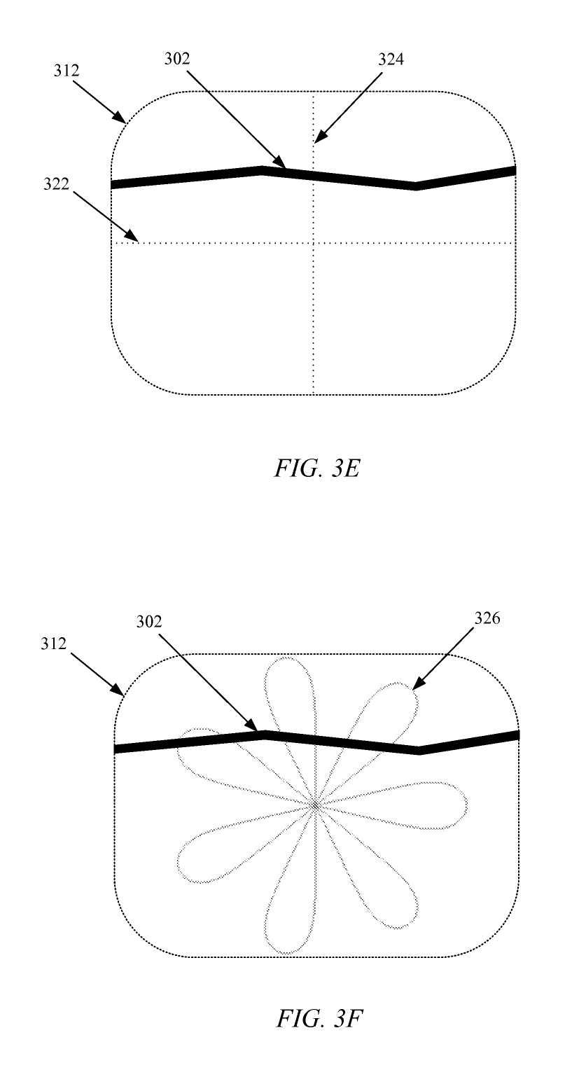

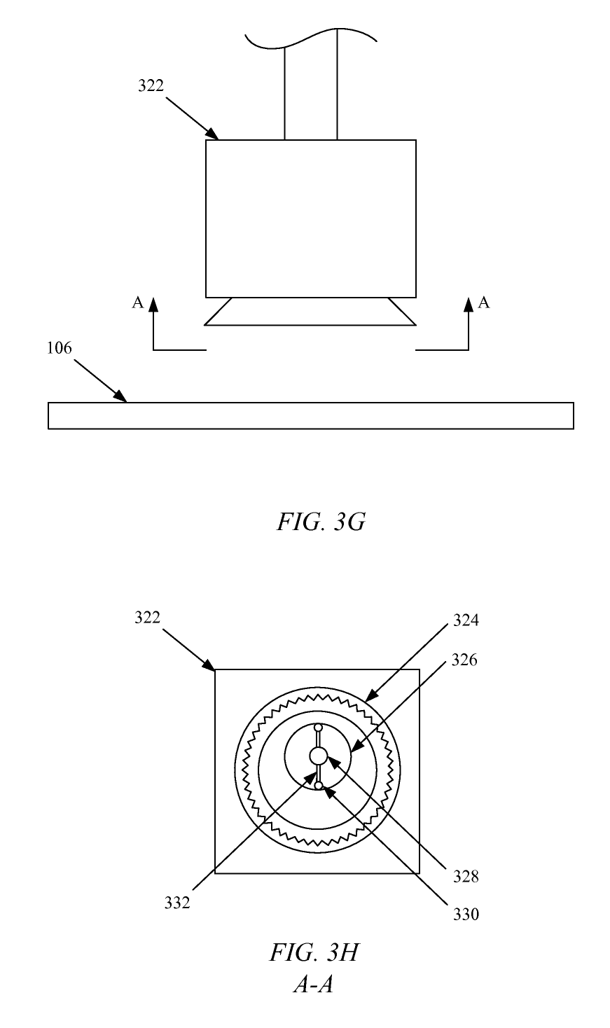

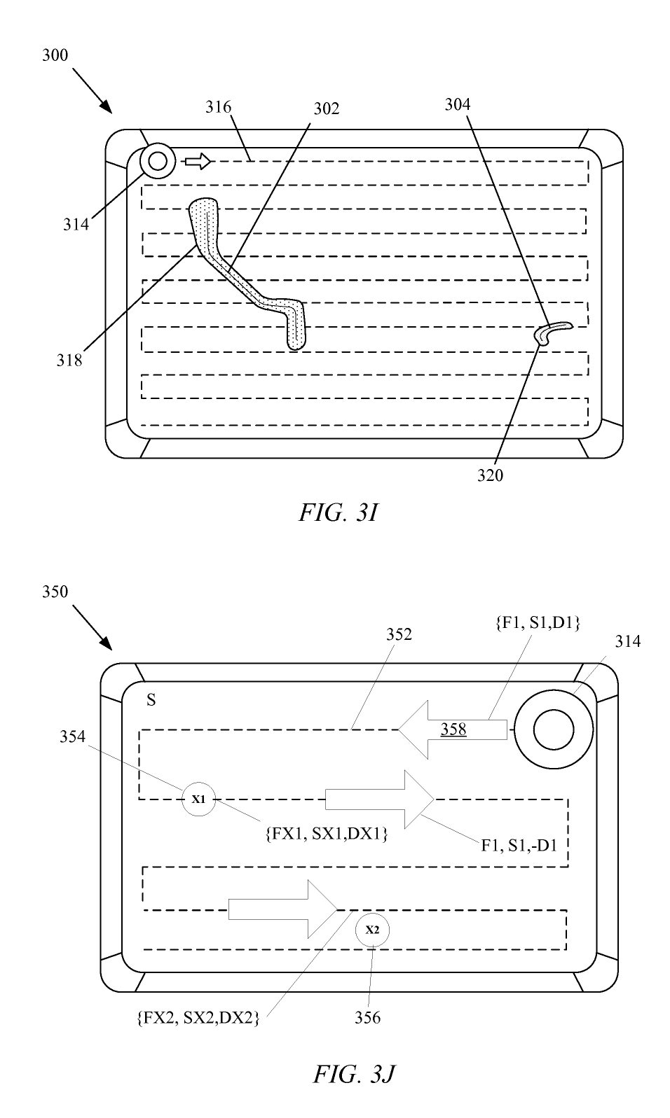

FIGS. 3A-3J illustrate representative imaging and finishing processes. In FIG. 3A a housing 300 is depicted. Housing 300 includes defects 302 and 304. Defects 302 and 304 can be caused by any number of factors during production. For example, defect 302 can be a result of mishandling. Defect 304 can be caused by inadvertent contact with another machining tool. Regardless of the cause defects can generally be attributed to mistakes during a manufacturing process. As such the depth and profile of such defects can be highly variable. FIG. 3B shows a defect identification step. During the defect identification step an imaging device takes pictures of a surface of housing 300. Generally, to obtain higher resolution imagery of the surface of the housing more pictures are taken from a relatively closer distance. FIG. 3B shows sixty-three image footprints 306; however, it should be noted that any number of footprints or configuration is possible. Each footprint 306 represents an area of the housing that can be recorded by an imaging device at a certain distance from the housing. Footprints 306 overlap with one another so that the images taken can be stitched together during an image processing operation. Image stitching can be especially useful when a defect covers more than one image footprint 306. Image overlap can also beneficially provide different angles of a defect located in the overlap. Differential imaging angles can sometimes provide more detailed information about the nature of a detected defect. For example, in some cases a different imaging angle can provide for a clearer view of a shadowed portion of a defect. Consequently, in some embodiments footprints 306 can be arranged such that each portion of a surface of housing 300 is imaged at least twice during any given defect identification step.

FIG. 3C shows how given only defects 302 and 304 only eight images of the depicted 63 in FIG. 3B are needed to characterize the two defects. Defect 304 spans image footprint 308 and 310. While in this case defect 304 is covered completely by image footprint 308, additional data from image footprint 310 can be useful in providing additional information about a portion of defect 302. Defect 302 spans six different image footprints. By stitching the six images together in an image processing operation, defect 302 can be fully characterized. In some operations both defects 302 and 304 can be subjected to additional imaging operations. For example, if the initial imaging operation were performed by a large CCD imager, then a confocal sensor or interferometer can be used in a second imaging operation to more fully characterize each detected defect. Because a general contour and surface position of the defect is known from the preceding defect detection step, the images taken by the more detailed imaging device can also include at least a portion of the detected defect. In this way a more time consuming high resolution imaging step can be applied only to portions of the housing that contain defects. FIG. 3D shows a close up view of detected defect 302. Overlaid on top of defect 302 are high-resolution footprints 312. As depicted, high-resolution footprints 312 blanket only the defect and are generally substantially smaller than imaging footprints taken of a balance of the surface of the housing. It should be noted that while high-resolution footprints 312 are shown staggered with respect to defect 302 any configuration is possible. In some cases, if a portion of the defect has been determined by a lower resolution imaging operation to have for example a depth less than dₘᵢₙ, then that portion of the defect can be skipped by the high resolution imaging operation. In this way, time can be saved by applying a time consuming high-resolution imaging operation only to portions of housing 300 that require correction.

FIGS. 3E and 3F show a magnified view of an individual high-resolution footprint 312 such as those shown in FIG. 3D. Defect 302 is shown tracking approximately horizontally across high-resolution footprint 312. High-resolution footprint 312 can be scanned during a secondary scanning operation using a higher-resolution three-dimensional scanner such as for example, a line laser, an interferometer, or a confocal sensor. These scanners can scan the surface of housing 300 along a line and return data points represent a depth measurement along the line. In order to collect data necessary for generating a finishing profile, a maximum and minimum depth value can be obtained within each high-resolution footprint 312. However, maximum and minimum depth values can vary depending on the direction of the line followed by the high-resolution scanner. For example, if the high resolution scanner follows path 322, the scan will not intersect defect 302 and a correct minimum depth value will not be obtained. A scanning path that is oriented substantially perpendicular to defect 302, such as path 324, is desirable for obtaining accurate depth values. However, the direction of defect 302 can be unknown at the time of the scanning operation.

FIG. 3F shows another instance of high-resolution footprint 312 demonstrating scanning path 326. Rather than follow a straight line, scanning path 326 can follow a sinusoidal spiral or hyperboloid path. Such a path ensures that the area within high-resolution footprint 312 is scanned in a large number of directions. This guarantees that scanning path 326 will pass through defect 302 at an approximately perpendicular angle at some point during the scanning process. Once scanning path 326 is complete, the maximum and minimum depth values obtained during the scan can be used to generate the finishing profile. It should be noted that a scanning path based on a sinusoidal spiral or hyperboloid is not required and any path that crosses high-resolution footprint 312 at a variety of angles can be used. It should also be noted that in embodiments utilizing a confocal sensor, the confocal sensor should be oriented substantially parallel to a surface of the part to successfully conduct imaging operations.

FIGS. 3G and 3H show scanning device 322, which is capable of following a scanning path similar to scanning path 326 in FIG. 3F. Scanning device 322 can be oriented towards surface 106 directly above an instance of high-resolution footprint 312. FIG. 3H shows view A-A, displaying the mechanism that directs scanning device 322. The aperture of scanning device 322 can include a planetary gear cam. An outer gear 324 can engage a motor to drive the planetary gear. Outer gear 324 can be coupled to an inner structure including an off-center opening 326. Sensor 328 can be positioned at the center of off-center opening 326 and can be coupled to two inner gears 330 by cams 332. When power is applied to the motor, the motion of outer gear 324 and inner gears 330 can cause sensor 328 to move along a path similar to a sinusoidal spiral or hyperboloid as is shown in FIG. 3F. The planetary gear can improve the efficiency and reliability of scanning device 322 by allowing sensor 328 to follow a complex path while using only one motor.

FIG. 3I shows one way in which a finishing profile can be adjusted based on characterized defects 302 and 304. Finishing tool 314 can be applied to a surface of housing 300 along finishing path 316. In this embodiment, finishing path 316 can be maintain as depicted regardless of the number of or configuration of defects detected. Affected zones 318 and 320 show an ideal area over which a smooth surface gradient can be created to eliminate defects 302 and 304. By creating such an area, the smooth gradients create an illusion of surface uniformity. Gradients associated with affected zones 318 and 320 can be more gradual with smoother surface finishes, as smoother surface finishes, such as a mirror finish, more easily show defects and surface irregularities than for example, a matte surface finish. Affected zones can have varying size with respect to a defect when the defect has varying depths. For example, a top portion of affected zone 318 is wider than a central part. Such a configuration of affected zone 318 indicates a top portion of defect 302 is deeper than a central portion of it. In this way, material removal can be minimized across the surface of housing 300.

In configurations as depicted, where finishing path 316 remains constant, affected zones 318 and 320 can be created by varying applied force, finishing tool, translational velocity, and operational parameters of finishing tool 314 such as for example finishing tool rotational speed. For example, as a leading edge of finishing tool 314 arrives at affected zone 318 the translational speed of finishing tool 314 can slow imparting more material removal as it translates. In some embodiments, the translational speed can be reduced in conjunction with a higher tool rotational speed and higher applied forces. It should be noted, that in some embodiments a standardized finishing path can be applied to housing 300 in which more finishing force is applied to affected zones 318 and/or 320 than to areas without defects. In the event that a first finishing operation is insufficient, a subsequent finishing path can then be designed to completely remove defects 302 and 304. The subsequent finishing path can be configured to smooth the gradient associated with the affected zones or to finish removing each of defects 302 and 304. In some embodiments a subsequent detection step can be included between the first and any subsequent finishing operations. In this way, processor 112 can calculate a subsequent finishing profile 120 based upon actual material removed as opposed to what was calculated to have been removed.

A determination of how much material is removed during a finishing operation can also be updated in real-time during the finishing operation. Finishing tool 314 can include a force-feedback sensor configured to provide information about how much force is being applied to housing 300 during a finishing operation. In one particular embodiment a six axis force feedback sensor can be used to measure force applied to the surface by finishing tool 314 and an amount of torque received by finishing tool 314 during operations. This information can be used to adjust parameters such as applied force and tool operational parameters to achieve a desired amount of material removal. Real-time updates can be important as conditions of polishing pads can degrade over time, thereby affecting polishing efficiency. Furthermore, certain defects can cause unexpected amounts of force to be exerted on finishing tool 314 during a finishing operation.

FIG. 3J shows another representative finishing profile for housing 350. In this embodiment finishing path 352 can be specifically configured to intersect with each of identified defect areas 354 and 356. In this way, finishing efficiency can be enhanced for a given finishing operation. As shown, arrow 358 indicates a direction of motion of finishing tool 314 where variables “F”, “S”, and “D” indicate force, speed, and direction, respectively, as called out by finishing profile 120. In this way, finishing profile 120 can provide that finishing tool 314 be programmed to apply force F1 at speed S1 in direction D1 on surface S up and until defect area 354 surrounding defect X1 is approached. In this situation, finishing tool 314 can apply force FX1 at speed SX1 in direction DX1 each of which have been selected to address the specific characteristics of defect X1. For example, if the characteristics of defect X1 are such that a greater force is applied by finishing tool 116 at a slower forward speed, then this information is used to control the actions of finishing tool 314 in the vicinity of defect X1. Once it has been determined that defect X1 has been repaired, the finishing tool 314 can proceed to finish the remainder of surface S. It should be noted, however, that as additional defects are approached by finishing tool 116, then the actions of finishing tool 116 can be altered based upon the information stored in finishing profile 120 based upon the characteristics of the specific defect. For example, finishing path 352 has been configured to pass just above and below defect X2. Such a configuration can allow finishing tool 314 to apply finishing operations to defect X2 on two different finishing passes. Such a configuration can allow a larger gradient to be created about defect X2, reducing noticeability of a resulting depression in a Surface S of housing 350. Such a configuration can be especially useful when defect X2 extends nearly to a depth dₘₐₓ into surface S of housing 350.

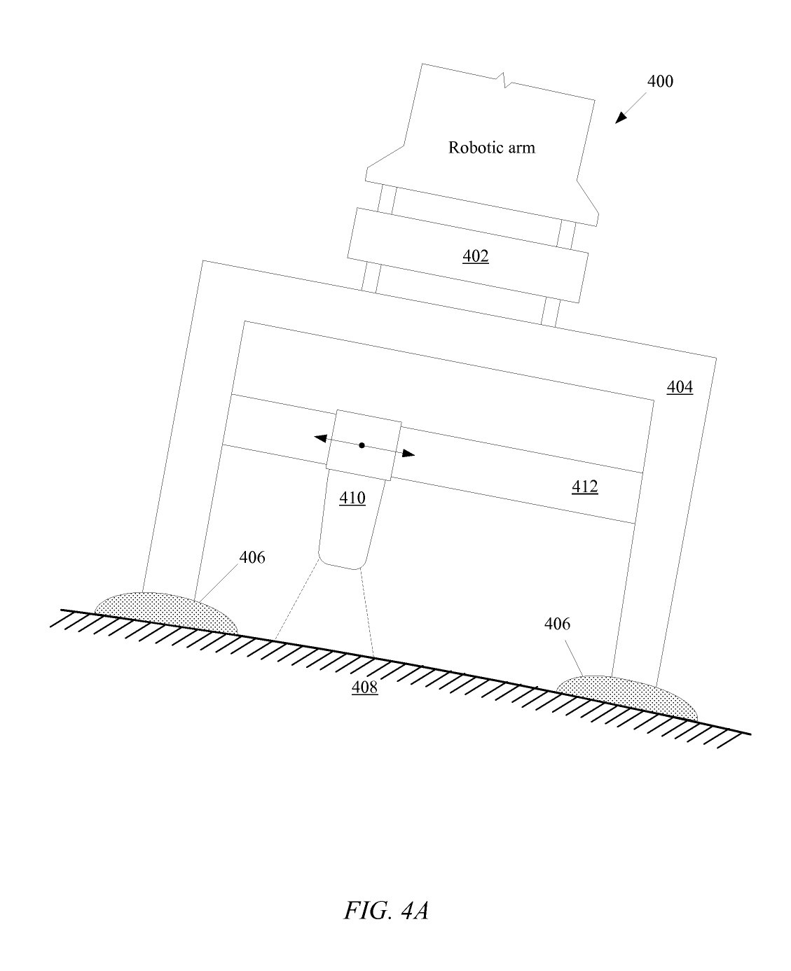

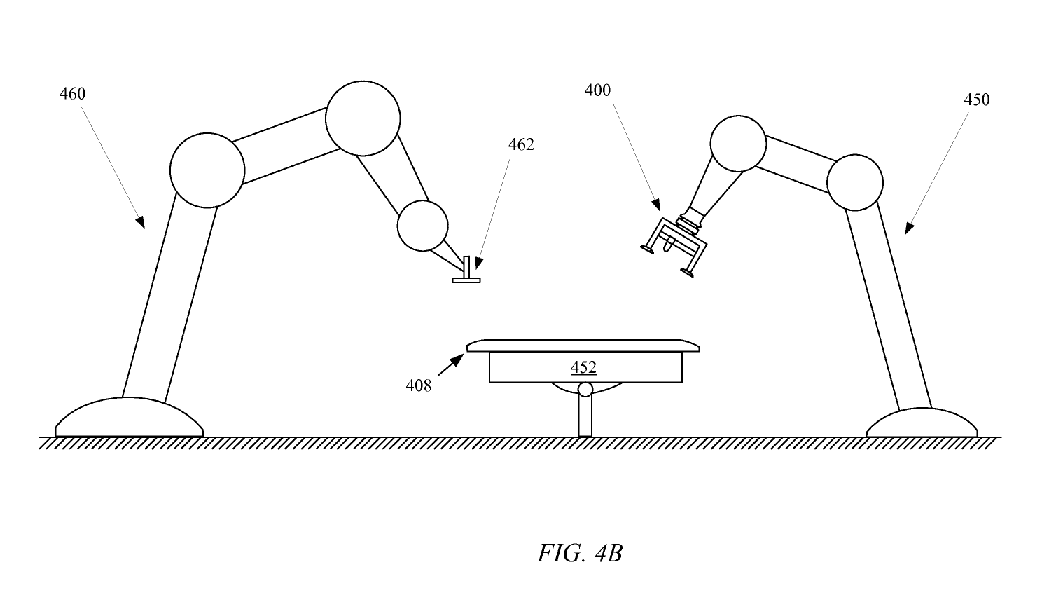

FIG. 4A illustrates a representative integrated robotic handler system 400 in accordance with the described embodiments. Integrated robotic handler system 400 can be used in those situations where the vision system used is sensitive to vibration. Vision systems that rely upon a confocal sensor, for example, can be adversely affected by motion in the form of vibration of either the part being finished or the vision system itself. Vibrations can be substantially reduced or eliminated by including vibration buffer 402 with robotic handler 404 having attachment features 406 (such as suction cups) for securing robotic handler 404 to part 408 during an imaging operation. Robotic handler 404 can act as a support structure for image capture device 410. In this arrangement, image capture device 410 can be mounted directly to robotic handler 404 and vibration buffer 402. Vibration buffer 402 can be configured to isolate robotic handler 404 from any vibrations caused by the robotic arm to which it is attached. In some embodiments, image capture device 410 can be movable with respect to robotic handler 404. For example, image capture device 410 can be mounted on rail system 412 configured to maneuver image capture device 410 with respect to a surface of part 408. While translation in only one dimension is depicted, the rail system can be configured to translate image capture device 410 in two or even three dimensions with respect to the surface of part 408. In this way, image capture device 410 can be maneuvered with respect to a detected defect without having to reposition robotic handler 404.

Robotic handler system 400 can be one component of a larger system used to finish part 408 as depicted in FIG. 4B. FIG. 4B shows robotic handler system 400 attached to robotic arm 450. Robotic arm 450 can be configured to attach robotic handler system 400 to any portion of housing during an imaging operation. In some embodiments robotic arm 450 can have up to 6 degrees of freedom for orienting robotic handler system at any possible orientation with respect to part 408, at which point it can apply suction cups 406 of robotic handler system 400 to part 408 to secure the system in place during an imaging operation. Part 408 can be held securely in place by fixture 452. Part 408 can be secured to fixture 452 by vacuum suction, clamps, screws, or even straps. Fixture 452 can be configured to hold part 408 in one position, or in some embodiments can be configured to maneuver part 408 to help to facilitate line up with an imaging device and/or a finishing tool. In the depicted embodiment robotic arm 460 can be configured to maneuver finishing tool 462 with respect to part 408. By providing separate robotic arms for each of robotic handler system 400 and finishing tool 462, imaging operations can be conducted concurrently with finishing operations. In this way, finishing profile 120 can be frequently updated during a finishing operation. In some embodiments when finishing operations cause vibration of part 408 sufficient to degrade imaging operations, imaging operations can be performed sequentially with finishing operations. Sequential imaging and finishing operations allow, for example, a determination of whether a defect has been completely removed from a surface of part 408. When the defect has not been completely removed, processor 112 can be used to determine a new finishing profile to allow finishing tool 462 to completely remove the remaining defect or defects.

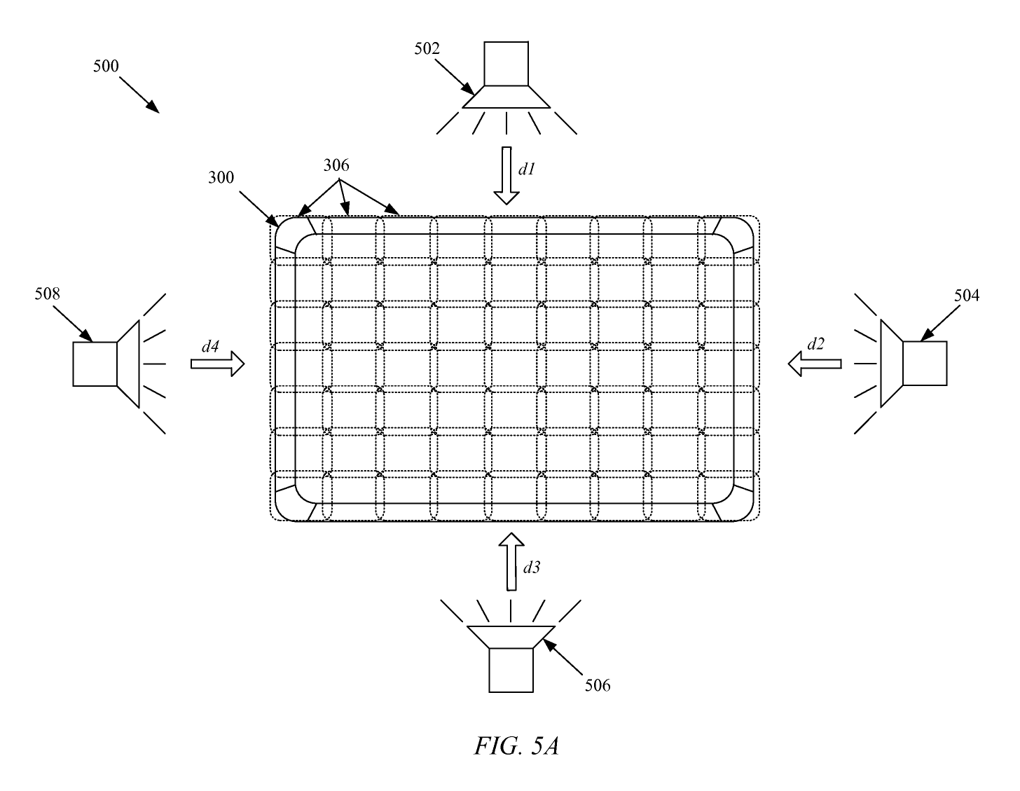

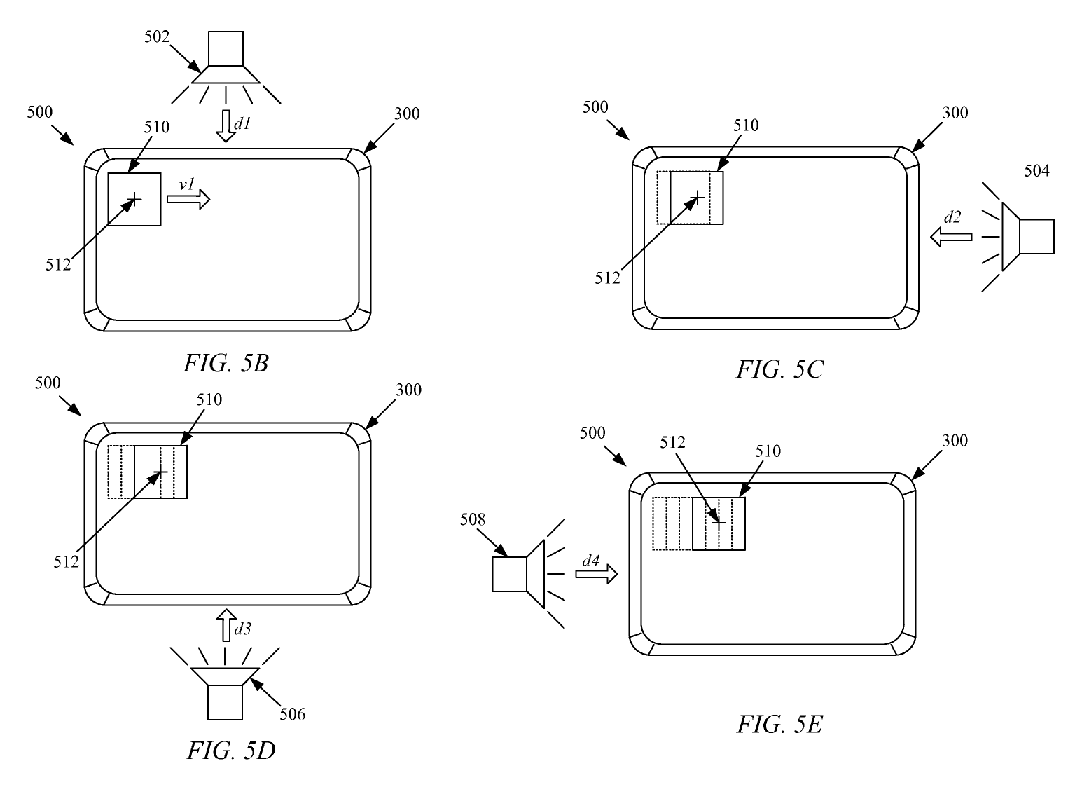

FIGS. 5A-5E show system 500 for performing a rough scan using multiple light sources. FIG. 5A shows a plan view of housing 300 within system 500. Housing 300 can be divided into individual footprints 306 similar to the method shown in FIG. 5B. Each footprint 306 can represent an image taken by an imaging device such as a CCD. When an image has been obtained for each footprint 306, the images can be stitched together to produce an image for defect analysis. Defects such as dents and scratches appear in the resulting image as regions relatively lighter or darker than the surrounding surface. This effect can result from light reflecting differently off defective areas of the surface. However, some defects are only visible when light is reflected off the defect at a certain angle. Therefore, a more accurate defect analysis can be performed by imaging the surface using multiple light sources.

In system 500, each footprint 306 can be imaged multiple times using light sources pointed in different directions. Four light sources spaced at 90 degree intervals are shown in FIG. 5A. However, any number of light sources positioned at any angle can be used and the present disclosure should not be limited to imaging systems using four light sources. In the example shown in FIG. 5A, a first image of a footprint 306 can be obtained while emitting light only from light source 502 pointed in direction d1. Next, footprint 306 can be imaged again with light provided only by light source 504 pointed in direction d2. Then, a third image can be obtained using only light from light source 506 pointed in direction d3. Finally, a fourth image can be obtained using only light from light source 508 pointed in direction d4. The four images analyzed together can provide a comprehensive image of footprint 306, resulting in a more accurate defect analysis. Four images can be obtained for each instance of footprint 306 and the images obtained using the same light source can be stitched together to form a single image for analysis. In other embodiments, more or less than four light sources can be used and the light sources can be placed at various angles depending on specific manufacturing and design criteria.

FIGS. 5B-5E show another embodiment of system 500 adapted to allow the imaging device to remain in constant motion during the imaging process. Housing 300 can be placed in system 500 under an imaging device capable of continuous motion along at least 1 axis. Outline 510 represents a periphery of the scanning area for the imaging device and point 512 represents the center point of the imaging device. FIG. 5B shows system 500 as the imaging process begins. The imaging device can obtain an initial image centered on point 512 using only light source 502 pointed in direction d1, then begin moving at velocity v1. When center point 512 has traveled a distance equivalent to one fourth of the distance across outline 510, as depicted in FIG. 5C, a second image can be obtained using only light from light source 504 pointed in direction d2. The process can be repeated as shown in FIGS. 5D and 5E, obtaining images using light from light source 506 and light source 508 respectively. Due to the overlapping nature of the images, the system can allow each area of housing 300 to be imaged from four directions while continuously moving the imaging device. Continuous movement can improve the cycle time of the scanning process. In addition, continuous movement can avoid settling time on the mechanisms controlling the movement of the imaging device, reducing wear and tear on the system.

In other embodiments, more or less than four light sources can be used during the imaging process. For example, a system utilizing three light sources spaced apart at 120 degrees can be used. Such a system increases the spacing between consecutive images from one fourth of the distance across outline 510 to one third the distance across outline 510. This can increase the cycle time of the scanning process but may reduce the ability of the system to detect all defects in housing 300. Conversely, adding more than four light sources will increase defect detection while slowing cycle time. In general, when n light sources are used, the spacing between consecutive images can be characterized as x/n where x represents a distance across outline 510 and n represents the number of light sources used.

When obtaining images using an imaging device in constant motion, a risk can arise that individual pixels within the image will “smear” in the direction of travel. If the degree of pixel smear becomes too large, the ability to identify defects in the image can be compromised. The amount of pixel smear can be modeled as a function of the linear travel speed of the imaging device and the shutter speed of the imaging device. Increasing the linear travel speed of the imaging device can result in increased pixel smear. Similarly, slowing the shutter speed of the imaging device can also result in increased pixel smear. Thus, the shutter speed and linear travel speed of system 500 can be selected to optimize cycle time while keeping the amount of pixel smear below a threshold level needed to detect defects in housing 300. The value of the threshold can vary based on the resolution required to observe defects in a particular application. In one embodiment, a threshold value of 8 microns can be sufficient to detect visual defects on a consumer electronic device. However, thresholds above or below 8 microns can be used in other situations. If an imaging device with a fastest shutter speed of 100 μs is used, then the highest velocity available to the imaging device while remaining below the threshold is approximately 80 mm/sec. If an imaging device with a faster shutter speed is used, then faster velocities can be attained while maintaining the same threshold value.

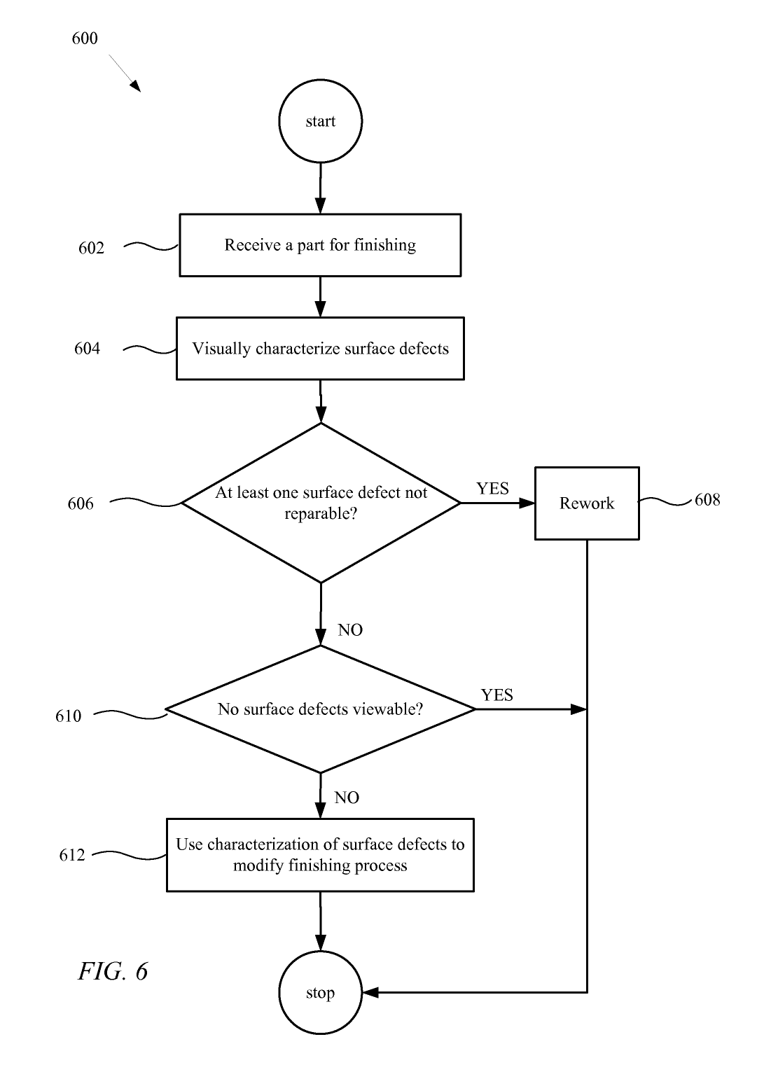

FIG. 6 shows a flowchart detailing a finishing characterization process 600 in accordance with the described embodiments. Process 600 can begin at 602 by receiving a part for finishing. At step 604, surface defects can be visually characterized. Visually characterizing the defects can be carried out using a vision system and processor as described above. At 606, if any of the characterized defects are not reparable, then the part is either sent to rework or discarded. By not reparable it is meant that at least one characteristic (such as depth) of at least one defect is such that that characteristic can not be brought into specification design limits within a pre-determined amount of time. For example, it has been determined that a scratch having a depth of 50 microns in aluminum is not reparable within an amount of time dictated by a cost effective manufacturing process. In this case, the part does not proceed to the finishing process and is sent to rework at 608. At 610, if no defect is determined to have any characteristic that is deemed to be viewable (such as a scratch having a depth less than 10 microns), then the part does not undergo defect repair; otherwise, at 612 characterization of the surface defects is used to modify the finishing process.

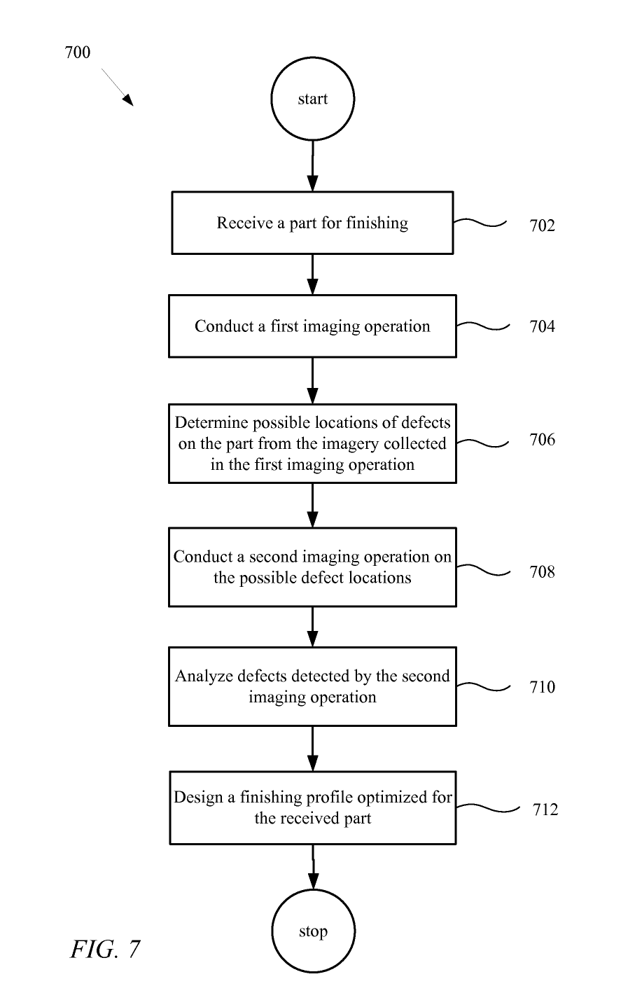

FIG. 7 shows a flowchart detailing a surface characterization process 700. At step 702 a part is received for a surface finishing operation. The received part can be substantially formed in terms of shape and features. The finishing operation can be a final operation prior to the part being ready for use. At step 704, a first imaging operation can be conducted. The first imaging operation can be accomplished through the use of a large scale CCD or CMOS (Complementary Metal Oxide Semiconductor) based imaging device. The imaging device can be configured with a lens allowing it to operate in close proximity to a surface of the part. At step 706 a series of images collected by the imaging device can undergo a first processing step. The first processing step can be a comparison of the collected images with baseline imagery. The baseline imagery can be taken of an exemplary part from the same positions relative to the part. In this way, any significant differences between the baseline imagery and the collected imagery of the part can be identified as potential areas containing defects. A defect can be for example, a scratch or gouge in the surface of the part marring an overall look and/or feel of the part.

At step 708 a second imaging operation can be conducted over the potential defect areas. The second imaging operation can be accomplished by the use of a three-dimensional imaging device, such as for example, an interferometer, a confocal sensor or a line laser. The three-dimensional imaging device can be stabilized with respect to the part to minimize relative movement by any number of stabilization constructs. In one particular embodiment the stabilization construct can couple the imaging device directly to the surface of the part. In this way motion blur can be avoided so that precise data is collected of each area potentially containing defects. At step 710 a processor can be configured to analyze data received from the three-dimensional imaging device. The three-dimensional imagery provides depth data for each detected defect area. The depth data can be compared against predefined minimum and maximum depth dimensions. The minimum depth dimension, previously dₘᵢₙ, is a depth at which the manufacturer can disregard the defect as it can be shallow enough to avoid notice. The maximum depth dimension is a depth at which too much material must be removed or too much time must be taken to remove the identified defect. Defects shallower than the minimum depth dimension are ignored and parts having a defect deeper than the maximum depth dimension are either discarded or sent to rework processing. Defects falling between the predefined dimensions are considered repairable during the finishing process. Assuming there are no defects greater than the maximum depth dimension, the three-dimensional imagery containing repairable defects is put through further analysis by the processor, which at step 712 provides a finishing profile configured to both create a desired surface finish along the surface of the part and remove the repairable defects. The finishing profile can contain variations in finishing path, force applied by the finishing tool to the surface, finishing tool speed, and operating parameters of the finishing tool.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method of finishing a housing surface, comprising:
analyzing imagery of at least a portion of the housing surface for a surface defect;
determining if the detected surface defect is reparable;
mapping each reparable surface defect to a position on the housing surface; and
modifying a finishing process of the housing surface in real-time for each of the reparable surface defects;
wherein the surface defect is reparable if a depth dimension of each detected surface defect is within a predefined range of depths considered reparable during a finishing operation.

2. The method as recited in claim 1, wherein the analyzed imagery comprises:
a first plurality of images taken at a first resolution, the first resolution providing enough detail to identify a location of each surface defect; and
a second plurality of images taken at a second resolution, the second resolution providing enough detail to provide a depth dimension for each identified surface defect,
wherein the second resolution is higher than the first resolution, and wherein the second plurality of images are taken only in locations of the housing surface containing defects identified in the first plurality of images.

3. The method as recited in claim 1, further comprising:
applying a rework process to the housing surface when the surface defect has a depth dimension exceeding the predefined range of depths.

4. The method as recited in claim 3, further comprising discarding imagery data without data corresponding to any reparable defects.

5. The method as recited in claim 3, wherein the predefined range of depths extends between about 5 and about 50 microns into the housing surface.

6. The method as recited in claim 1, further comprising taking a plurality of images of the housing surface, wherein at least two of the plurality of images at least partially overlap, the at least two overlapping images providing additional information about any defects positioned in the image overlap.

7. The method as recited in claim 2, the first plurality of images further comprising at least a first set of images and a second set of images, wherein the first set of images are obtained while illuminating the housing surface from a first direction and the second set of images are obtained while illuminating the housing surface from a second direction substantially different from the first direction.

8. The method as recited in claim 7, wherein the first plurality of images are obtained with an imaging device configured to remain in motion while the first and second sets of images are obtained, wherein the imaging device alternates between obtaining images illuminated from the first direction and obtaining images illuminated from the second direction.

9. The method as recited in claim 8, wherein a velocity of the imaging device and a shutter speed of the imaging device are selected to maintain a pixel smear no greater than approximately 8 microns.

10. The method as recited in claim 2, the second plurality of images further comprising a series of depth values obtained along a sinusoidal spiral pattern, wherein the depth dimension of each identified surface defect is obtained by comparing a maximum depth value obtained along the sinusoidal spiral pattern to a minimum depth value obtained along the sinusoidal spiral pattern.

11. A method of adapting a finishing profile to a housing surface, the method comprising:
imaging the housing surface;
analyzing the imagery of the housing surface to detect surface defects disposed along the housing surface;
determining which of the detected surface defects are within a predefined range of depths considered reparable during a finishing operation; and
configuring the finishing profile for creation of a desired finish along the surface of the housing and removal of each of the reparable surface defects during the finishing operation.

12. The method as recited in claim 11, further comprising discarding imagery that does not contain information about any of the detected surface defects.

13. The method as recited in claim 11, wherein the imaging of the housing surface comprises:
capturing a first plurality of images of the housing surface;
comparing the first plurality of images with a baseline plurality of images to determine differences between the housing surface and an exemplary housing surface without defects;
identifying possible surface defect locations based on the comparison; and
capturing a second plurality of images only at locations along the housing surface identified as possible surface defect locations,
wherein the second plurality of images includes more detail than the first plurality of images.

14. The method as recited in claim 13, wherein the first plurality of images produces two-dimensional imagery of the housing surface and the second plurality of images produces three-dimensional imagery of the housing surface.

15. The method as recited in claim 11, wherein the configuring the finishing profile comprises making adjustments to at least one of a finishing path, a finishing tool velocity, and a finishing tool operating parameter.

16. The method as recited in claim 11, wherein the predefined range of depths is between about 10 microns and about 50 microns.

17. The method as recited in claim 11, wherein the imagery of the housing surface comprises a plurality of overlapping images of the housing surface.

18. A finishing system for applying a finishing operation to a surface of a housing, the finishing system comprising:
a vision system configured to provide imagery of any surface defects disposed along the surface of the housing;
a processor configured to analyze the provided imagery and to design a finishing profile for creating a desired surface finish on the surface of the housing and removing any detected surface defects from the surface of the housing; and
a finishing tool configured to execute the finishing profile,
wherein the processor is in communication with both the finishing tool and the vision system, and wherein the processor is configured to stop a finishing operation for a housing which is determined to have a defect with a depth dimension exceeding a predefined depth threshold.

19. The finishing system as recited in claim 18, wherein the vision system comprises:
a support structure configured to maneuver an imaging device with respect to the surface of the housing to which the support structure is configured to be secured;
a robotic arm configured to maneuver the support structure with respect to the housing between imaging operations;
a buffer configured to reduce an effect of vibrations transmitted through the attached robotic arm during each imaging operation; and
a plurality of attachment features configured to secure the support structure to the housing during each imaging operation,
wherein the buffer and plurality of attachment features maintain the support structure in the same reference frame as the housing during an imaging operation, thereby increasing performance of the imaging device.

20. The finishing system as recited in claim 19, wherein the support structure is configured to maneuver the imaging device in at least two dimensions with respect to the surface of the housing.

21. The finishing system as recited in claim 18, wherein the vision system comprises a first imaging device and a second imaging device, the first imaging device configured to cue the second imaging device to areas of the surface of the housing having defects.

22. The finishing system as recited in claim 18, wherein the finishing tool is configured to be maneuvered across the surface of the housing during a finishing operation by a robotic arm, and wherein the finishing tool is configured to execute a finishing operation in accordance with the processor provided finishing profile.

23. The finishing system as recited in claim 22, wherein the robotic arm associated with the finishing tool is maneuverable in 6 degrees of freedom.

24. The finishing system as recited in claim 21, wherein a finishing path, finishing tool speed, and finishing tool operational parameters can each be adjusted in accordance with characterization data received from the vision system.

25. The finishing system as recited in claim 21, wherein the second imaging device further comprises a confocal lens coupled to a planetary gear cam.
